(19) United States
(12) Patent Application Publication
(10) Pub. No.: US 2008/0134920 A1
(43) Pub. Date: Jun. 12, 2008

(54) Security Element and Printing Method

(76) Inventors: Gianfranco Foresti, Ecublens (CH); Jerome Badan, Lausanne (CH)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/543,988

(22) PCT Filed: Feb. 5, 2004
(86) PCT No.: PCT/IB04/00399

§ 371 Date: Dec. 14, 2007

(30) Foreign Application Priority Data
Feb. 13, 2003 (EP) 03003332.8

(51) Int. Cl. B41F 31/00

(52) U.S. Cl. 101/491; 283/72

(57) ABSTRACT

The security element comprises a background (1) with juxtaposed geometrical elements (2 to 8) each formed by a set of lines, the lines of a geometrical element having a different angle to those of an adjacent element. The lines of a part of the geometric elements are printed with a conventional ink and the lines of other parts of the geometrical elements are printed with an ink having metallic characteristics.

### BACKGROUND OF THE INVENTION

The present invention relates to a security element for documents, such as paper securities, passports, cards and identity cards, checks, banknotes and other similar documents for example.

The present invention relates to a method of printing a security element for documents, such as paper securities, passports, cards and identity cards, checks, banknotes and other similar documents for example.

In the field of paper securities, particularly banknotes, there is an increasing need for security elements as protection against forgery. In the last few years, computers, scanners and photocopiers have undergone appreciable technical improvements and it is currently possible to purchase high-performance equipment at a reasonable price. As the performance of this equipment has become very good, it has become necessary to develop new security elements, which themselves also perform better, for paper securities such as banknotes, checks, credit cards, passports or identity documents and other similar documents so as to protect these documents against forgery and prevent them from being able to be copied by present-day computers, scanners and photocopiers.

Such security elements use, for example, special-purpose inks such as optically variable inks (“OVI”®), metallic inks and other inks that have iridescent properties, these inks being used to print special patterns or geometric shapes on the substrate of the paper security, optically variable devices (“OVD”®) in the form of metallized patches (known as “foils”) or holograms, and also moirés and other similar patterns all of these being, on the one hand, very difficult if not impossible to copy with current equipment and also, on the other hand, very easy to check visually or with the naked eye.

Other security elements are formed of combinations of superposition of lines and/or patterns with colors, which are visible only under certain conditions, for example under UV light or by transparency. Once again, the benefit of such security elements is that they are easy to print or to place on the document that is to be protected and can be checked using simple equipment, even using the naked eye, but are impossible to reproduce using present-day printers, scanners and photocopiers.

### DESCRIPTION OF THE PRIOR ART

By way of example, U.S. Pat. No. 6,050,606 incorporated by reference into this application, describes a security element for paper securities, for example for banknotes. This security element is formed of a background having at least two juxtaposed regions, each region comprising its own geometric designs, said regions having a different color density. The security element further comprises a pattern corresponding to the region of lowest color density which is printed in superposition on said region in a chosen color so as to compensate for the difference in color density between said two regions. Thus, the security element appears uniform and patternless to the naked eye, but the pattern becomes clearly visible if said element is photocopied.

U.S. Pat. No. 5,443,579, incorporated by reference into this application, describes another method for printing a latent image on a substrate. According to that patent, the printing of lines in relief is combined with the printing of lines without relief. Thus, a latent color image is created that cannot be reproduced with a photocopier or other photomechanical methods.

U.S. Pat. No. 5,853,197 and U.S. Pat. No. 5,487,567, incorporated by reference into this application, display security elements which are not easily visible to the naked eye but which, by contrast, become clearly evident when the element is reproduced by photocopying or scanning.

Another technique employs watermarks in which the substrate, for example paper, is marked with lines or a pattern which are visible only in transparency. Another development of this technique relates to pseudo-watermarks formed by the creation of a window in the substrate, this technique being used in particular with paper substrates which are not themselves normally transparent, said window for its part being transparent.

Application EP 0 614 133 describes a security document having a printed background comprising geometric elements containing collections of printed lines with a first density. This document also comprises a canceling pattern printed with a second density. A copy of the security document has the effect that the canceling pattern appears visibly on the document, identifying it as a forgery.

### SUMMARY OF THE INVENTION

The object of the invention is to improve the known security elements and the methods of producing such elements.

More specifically, one object of the invention is to create a security element for paper securities improving the elements already known and requiring only a method that is simple and easy to implement.

Another object of the invention is to make available a security element that is very difficult to copy and to forge using standard modern scanners and photocopiers and other equivalent equipment but which can be easily printed using present-day printing means.

To this end, the invention comprises the characteristics defined in the claims.

### DESCRIPTION OF THE DRAWINGS

The invention will be better understood from the description of several embodiments thereof and from the figures relating to them, in which:

FIG. 1 shows a first embodiment of the security element according to the invention,

FIG. 2 shows a variant of the first embodiment of the security element according to the invention,

FIGS. 3a to 3f show several variants of the first embodiment,

FIG. 4 shows a second embodiment of the invention, and

FIG. 5 shows a variant of the second embodiment, and

FIG. 6 shows a block diagram of the method according to the invention.

### DESCRIPTION OF THE PREFERRED EMBODIMENTS

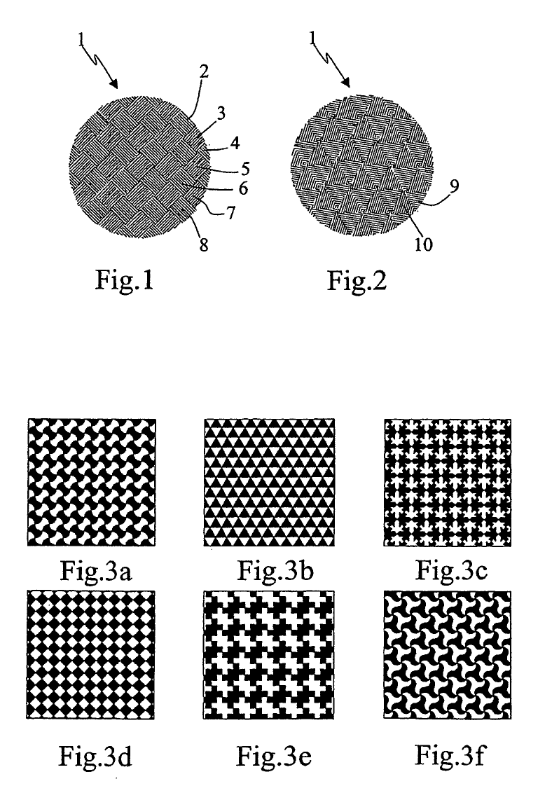

The first embodiment of FIG. 1 shows a security element 1, of circular overall shape, comprising a background formed of a plurality of geometric elements 2 to 8 which individually have a rectangular shape. To simplify the depiction, only some of the geometric elements have been referenced. These geometric elements are themselves formed of a plurality of parallel lines. According to the invention, the lines forming two adjacent geometric elements are not parallel but are at an angle to one another, for example at 30°, 45°, 60° or alternatively 90°.

In addition, the geometric elements are printed with two different inks so that adjacent elements, in the manner of a checkerboard, are alternately printed with a conventional offset ink, and with an ink possessing brightness or a light-reflecting effect, such as a metallic ink, an optically variable ink, or an iridescent ink for example.

Thus, for example, the geometric elements 2, 4, 6 and 8 are printed with a conventional offset ink, and the elements 3, 5, 7 are printed with the ink that has brightness and this scheme is repeated over the entire background of the security element 1. More generally, it can be said that the elements the lines of which are orientated in the same direction are printed with the same ink.

In addition, the two inks used have to have basic shades that are as close as possible, such as a gold (metallic) ink with a brown offset ink, or alternatively a silver ink with a gray offset ink, or alternatively a golden ink with a yellow offset ink.

These pairs of shades are of course given by way of example, and other pairs are of course possible.

Security elements according to this invention are preferably printed using a two-color offset method, for example using a printing press as known from U.S. Pat. No. 6,101,939.

The optical effect obtained by this printing is as follows: when the printed element is considered at right angles to the printed surface, the printed element appears to be flat tint, whereas upon a change (shift) in the viewing angle, the printed element splits into two parts and the “checkerboard” pattern appears, revealing the individual geometric elements.

FIG. 2 depicts a variant of this embodiment. This variant consists in using equilateral triangles as geometric elements 9, 10 to form the background of the printing with parallel lines. In this variant, the procedure is as in the embodiment of FIG. 1, namely alternately using conventional offset ink and ink with a brightness effect for the adjacent geometric elements, in the manner of a checkerboard.

The optical effect described hereinabove appears in the same way if triangular geometric elements are used.

FIGS. 3a to 3f show various configurations of background that can be used to form the checkerboard described. These backgrounds may also be termed pavements. As can be seen, numerous equivalent geometric shapes are possible, such as squares (3d), triangles (3b), “leaves” (3c), “swirls” (3f) and others still (FIGS. 3a and 3e).

As described hereinabove, the pale geometric elements of these figures may be printed using a conventional offset ink and the dark geometric elements of these figures may be printed using an ink with a brightness effect (or vice versa), for example with the pairs of colors mentioned hereinabove.

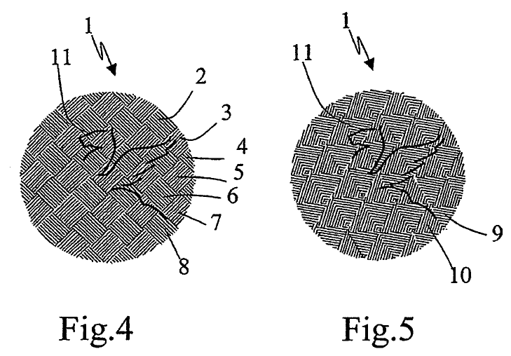

In order to enhance the optical effect obtained, it is also possible to add a readily identifiable pattern to the background. This embodiment is depicted in FIGS. 4 and 5, in which figures a pattern of Pegasus 11 has been added to the background of FIGS. 1 and 2, respectively. In these FIGS. 4 and 5, the elements which are identical to those of FIGS. 1 and 2 are referenced identically. The principle for the background in this embodiment is the same as the one described with reference to the preceding figures, namely the printing of geometric elements (rectangular ones 2 to 8 in FIG. 4, or triangular ones 9 and 10 in FIG. 5) in the manner of a checkerboard using two inks that have different properties as described hereinabove. The added pattern 11 is also printed using ink displaying a brightness effect with a shade identical or close to the one used for the background.

The effect is therefore enhanced in that the added pattern 11 also “shifts” according to the angle of view, and appears or disappears when the angle at which the security element is viewed is modified.

Any pattern may of course by printed, such as a logo, an alphanumeric pattern, or combinations thereof.

Thus there is obtained an optical effect that is impossible to copy by photocopying or scanning but which is very easy to check with the naked eye, with an instant result, or using simple optical means.

The dimensions used are preferably as follows:
line thickness: approximately 75 microns,
distance between two lines: approximately 125 microns,
area of the security element: approximately 1.5 cm².

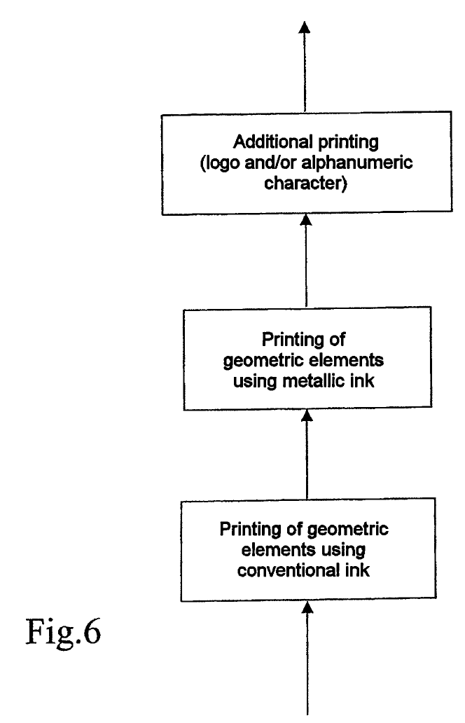

FIG. 6 shows a block diagram of the method according to the invention.

According to the method of the invention, the lines of some of the geometric elements are printed with a conventional ink and the lines of some more of the geometric elements are printed with an ink that has metallic characteristics. Of course, the order of printing is unimportant and the steps indicated hereinabove may be reversed.

As a preference, the lines of the geometric elements are printed using an offset method.

In the method according to the invention, the conventional ink is preferably in a gray color and the metallic ink is in a metal gray color, or alternatively the conventional ink is in a brown color and the metallic ink is in a gold color, or alternatively the conventional ink is in a yellow color and the metallic ink is in a golden color.

The embodiments of the invention given hereinabove are so by way of example and variations are of course possible within the scope of the protection claimed using equivalent means.

Other shapes of geometric elements are entirely possible, as are other colors, the idea being to form pairs of colors of a similar or even identical shade, but with different characteristics, relatively matt in the case of the conventional colors and shiny/iridescent in the case of the colors with a metallic characteristic.

1. A security element for documents, for example for paper securities, passports, cards and identity cards, checks, banknotes and other similar documents, comprising a background having juxtaposed geometric elements distributed uniformly in a checkerboard pattern each formed of a collection of lines, the lines of one geometric element being at a different angle from the lines of an adjacent element, wherein the lines of the geometric elements are printed with two different inks so that adjacent geometric elements are printed alternately with a conventional ink and with an ink possessing brightness, said inks having a similar basic shade.

2. The security element as claimed in claim 1, in which said geometric elements have the shape of squares or equilateral triangles.

3. The security element as claimed in claim 1, in which the conventional ink is in a gray color and the ink possessing brightness is in a metal gray color, or alternatively the conventional ink is in a brown color and the ink possessing brightness is in a gold color, or alternatively the conventional ink is in a yellow color and the ink possessing brightness is in a golden color.

4. The security element as claimed in claim 1, in which the lines are of the order of 75 microns thick.

5. The security element as claimed in claim 1, in which adjacent lines are separated by a distance of the order of 125 microns.

6. The security element as claimed in claim 1, which further comprises additional printing superposed on said background.

7. The security element as claimed in claim 6, in which said additional printing is in ink possessing brightness.

8. The security element as claimed in claim 7, in which said additional printing forms alphanumeric characters and/or a logo.

9. The security element as claimed in claim 1, wherein the ink possessing brightness is a metallic ink or an optically variable ink or an iridescent ink.

10. A method of printing a security element for documents, such as paper securities, passports, cards and identity cards, checks, banknotes and other similar documents for example, with a background comprising juxtaposed geometric elements distributed uniformly in a checkerboard pattern each formed of a collection of lines, the lines of one geometric element being at a different angle from the lines of an adjacent element, wherein the lines of the geometric elements are printed with two different inks so that adjacent geometric elements are printed alternately with a conventional ink and with an ink possessing brightness, said inks having a similar basic shade.

11. The method as claimed in claim 10, in which the lines of the geometric elements are printed using an offset technique.

12. The method as claimed in claim 10, in which the conventional ink is in a gray color and the ink possessing brightness is in a metal gray color, or alternatively the conventional ink is in a brown color and the ink possessing brightness is in a gold color, or alternatively the conventional ink is in a yellow color and the ink possessing brightness is in a golden color.

13. The method as claimed in claim 10, in which an additional pattern is printed on the background.

14. The method as claimed in claim 13, in which the additional pattern is in an ink possessing brightness.

15. The method as claimed in claim 10, in which the lines are printed with a thickness of the order of 75 microns.

16. The method as claimed in claim 10, in which the lines are printed with a distance of the order of 125 microns between adjacent lines.

17. The method as claimed in claim 10, wherein the ink possessing brightness is a metallic ink or an optically variable ink or an iridescent ink.
